(19) United States
(12) Patent Application Publication
(10) Pub. No.: US 2016/0123849 A1
(43) Pub. Date: May 5, 2016

(54) METHOD AND APPARATUS FOR THE PREPARATION OF KNOWN QUANTITIES OF GASES AND VAPORS

(71) Applicant: ULTRASNIFF, LLC, Bowling Green, KY (US)

(72) Inventor: HANK WOHLTJEN, BOWLING GREEN, KY (US)

(21) Appl. No.: 14/897,003

(22) PCT Filed: Jun. 23, 2014
(86) PCT No.: PCT/US14/43697

§ 371 Date: Dec. 9, 2015

Related U.S. Application Data
(60) Provisional application No. 61/838,683, filed on Jun. 24, 2013.

(51) Int. Cl. G01N 1/22

(52) U.S. Cl. CPC G01N 1/2226; G01N 2001/2229

(57) ABSTRACT

The invention provides an apparatus, system and method for providing precise concentrations of vapor for sensor calibration. The apparatus, and associated method, comprises (a) a constant volume reservoir containing a vapor source comprising a liquid containing the vapor to be generated, such that said liquid in the reservoir is in equilibrium with a headspace volume in the reservoir at a given reservoir temperature; (b) a temperature controller for precisely controlling the temperature of the constant volume reservoir; (c) a source of positive pressure for imparting a precisely controlled pressure to the interior of the constant volume reservoir; and (d) a seal through which or in which at least one tube is insertable into or sealingly retained in the constant volume reservoir, while maintaining a seal to ambient air surrounding the reservoir, such that precisely metered quantities of vapor are dispensed from the reservoir via the tube to a chemical sensor requiring calibration, upon pressurization of the constant volume reservoir to a pressure above atmospheric pressure, by the source of positive pressure.

### FIELD OF THE INVENTION

Methods and apparatuses for the preparation of known quantities of gases and vapors, including for sensor calibration.

### BACKGROUND OF THE INVENTION

There are many situations in which it is important to know the concentrations of gases and vapors. Examples include, but are not limited to, monitoring of gases and vapors in the environment, in chemical manufacturing processes, in chemical warfare and in medical diagnostic and treatment procedures. Accordingly, a broad spectrum of chemical sensor technologies have been developed to quantitatively detect and measure the gases and vapors of interest. Most of these technologies require that the sensor be calibrated in order to ensure the accuracy of the gas and vapor concentrations being measured.

Many methods are well known for the preparation of gas and vapor “standards” that can be used to calibrate chemical sensors (see, for example, Nelson, G. O.; “Controlled Test Atmospheres: Principles & Techniques”; Ann Arbor Science Publishers; 1982). It is common to use cylinders of compressed gas (e.g., pure air or nitrogen) to which a known amount of the desired calibration gas or vapor has been added (see, e.g., ISO Standard No. ISO 6142:2001(E); “Gas analysis—Preparation of calibration gas mixtures—Gravimetric method”). Such blended compressed gas standards are very reliable and easy to use but suffer from the disadvantage that they are often large, heavy and cannot be transported by aircraft or other means of transport unless elaborate and often expensive safety measures are implemented. Furthermore such gas standards have a limited “shelf-life” after which the accuracy of the standard concentration degrades.

Vapor standards can also be prepared by bubbling a carrier gas (e.g., pure air or nitrogen) through a reservoir (e.g., a vaporizer) containing a liquid sample of the vapor to be generated. By controlling the temperature of the bubbler and the flow rate of the carrier gas, a known amount of the target vapor can be delivered. This concentrated vapor stream can be blended with additional carrier gas to reduce the concentration as required to achieve the desired concentration for sensor calibration (see, e.g., Grate, J. W., Ballantine, D. S., Wohltjen, H.; “An automated vapor-generation and data collection instrument for the evaluation of chemical microsensors”; Sensors & Actuators, 1987, 11(2): 173). However, this methodology is not well suited for field-portable systems since the bubblers are usually physically large and prone to leakage if tipped over. Furthermore, in addition to accurate temperature control of the bubbler and flow control of the carrier gas, heating of the vapor flow path is required to prevent vapor condensation. Therefore, overall, this known methodology is not well suited when a compact or portable system is required.

Another popular method relies on the diffusion of gases and vapors from a concentrated reservoir through an orifice or small diameter tube of precisely known dimensions (see, e.g., Altshuller, A. P., Cohen, I. R., “Application of Diffusion Cells to Production of Known Concentration of Gaseous Hydrocarbons”, Anal. Chem., 1960, 32(7): 802). The diffusion rate of the gas or vapor through the tube is defined by its molecular properties as well as the temperature, pressure, diameter and length of the tube. By holding these parameters constant, the rate of diffusion is constant. Gases and vapors delivered from the diffusion tube can be blended with a stream of pure carrier gas (e.g., air or nitrogen) to provide a known concentration suitable for sensor calibration. However, as with other known methods, this method suffers from the disadvantage that it requires significant time for equilibrium to be achieved. That is, the temperatures, pressures and dilution air-flow rates must all be controlled and stabilized before accurate concentrations can be delivered. Furthermore, the vapor diffusion sources are “open”. This means that tipping of the source can result in the leakage of the calibration liquid contained in the reservoir. Overall, therefore, this methodology is also not well suited for a compact or portable vapor calibration system.

The problem of spillage from the vapor reservoir is mitigated by another popular vapor standard generation technique that relies on the controlled rate of diffusion of vapors through a polymer diffusion barrier. Such “permeation tubes” typically contain a small quantity of liquid sealed in a short length of Teflon™ tube. Liquid vapors are able to permeate the polymer matrix and slowly escape from the tube. The permeation rate depends on temperature and pressure. Like the diffusion tube, the permeation tube requires that all temperatures, pressures and flow rates be stabilized before accurate concentrations can be delivered. For most permeation tubes, this stabilization process can take hours. This methodology, too, therefore, is not well suited for use in a compact or portable vapor calibration system.

A popular alternative method for preparing gas and vapor standards is to use a manual syringe to inject a small quantity of “pure” gas or headspace vapor from a liquid reservoir into a larger vessel (e.g., a plastic bag or larger syringe) and then to fill the larger vessel with a known volume of clean air or nitrogen. If the pure gas or vapor headspace concentration is known, the concentration in the larger vessel can be determined. This method typically affords only modest accuracy, since the volumes delivered by the manual syringes are affected by the skill of the operator.

Yet another approach was described recently by Wohltjen in U.S. Pat. No. 7,484,399, in which a small volume of liquid contained in a small, electrically-heated chamber isolated by a solenoid valve, is used. When the heater is energized, the temperature and pressure in the chamber are increased, thereby permitting a small amount of the vapor to be dispensed through the solenoid valve when it is energized. While compact, rugged, and reliable, the concentrations delivered are not as precisely accurate as may be desired, since the external air-flow rates and temperatures are not controlled.

There are other vapor generation methods that are known to those skilled in the art. However, none of these known methods are well suited to provide accurate vapor concentrations using an apparatus that is very compact, free of high-pressure compressed gases and capable of high accuracy with minimal warm-up and user skill and which is sufficiently robust to facilitate use in a wide variety of contexts.

The present invention provides a new method and apparatus for preparing known concentrations of gases and vapors that can be used to calibrate chemical sensor devices. Therefore, this invention solves the problems identified in the art, as discussed above, and provides a solution for which there has been a long-felt need.

### SUMMARY OF THE INVENTION

The invention provides an apparatus, system and method for providing precise concentrations of vapor for sensor calibration and other applications. The apparatus, and associated method, comprises (a) a constant volume reservoir containing a vapor source comprising a liquid containing the vapor to be generated, such that said liquid in the reservoir is in equilibrium with a headspace volume in the reservoir at a given reservoir temperature; (b) a temperature controller for precisely controlling the temperature of the constant volume reservoir; (c) a source of positive pressure for imparting a precisely controlled pressure to the interior of the constant volume reservoir; and (d) a seal (e.g. a septum, O-rings, gaskets and the like) through which a tube is insertable into the constant volume reservoir, while maintaining a seal to ambient air surrounding the reservoir, such that precisely metered quantities of vapor are dispensed from the reservoir via the tube to a chemical sensor requiring calibration, upon pressurization of the constant volume reservoir to a pressure above atmospheric pressure, by the source of positive pressure.

Accordingly, it is an object of this invention to provide an apparatus, system and method for production and delivery of precisely known concentrations of a vapor to a sensor for calibration thereof.

Other objects, advantages and benefits of the present invention will become apparent to those skilled in the art from a review of the complete disclosure and the appended claims.

### BRIEF DESCRIPTION OF THE DRAWINGS

FIG. 1—Functional diagram of the calibrator device 100 of this invention.

FIG. 2—Example of a crimp top vial which may be used as the constant volume reservoir 101 according to this invention.

FIG. 3—Functional diagram of the calibrator device 200 of this invention.

FIGS. 4—2-butanone concentration measured versus dilution factor.

FIG. 5—Average 2-butanone concentration showing repeatability of the device for calibration.

### DETAILED DISCLOSURE OF THE PREFERRED EMBODIMENTS AND OPERATION OF THE INVENTION

The well-known Ideal Gas Law, first described by Clapeyron in 1834, provides a good approximation of the behavior of gases and vapors under various pressures, temperatures and volumes. The law is defined by the equation:

PV=NkT where;
P is the absolute pressure
V is the volume
T is the absolute temperature
N is the number of molecules in the gas, and
k is the Boltzman Constant

The concentration of a gas or vapor is defined as the number of molecules (N) per unit of volume (V). Thus, to find the concentration of a gas, the Ideal Gas Law is re-arranged as follows:

N/V=P/kT

Therefore, preparation of precise vapor concentrations requires accurate knowledge of the temperature and pressure of the vapor source.

The apparatus and method of the present invention provides a temperature controller, a source of positive pressure and constant volume reservoir so that accurate gas and vapor concentrations can be prepared and dispensed, for example, to a chemical sensor requiring calibration or to a receptacle for the vapor which can be used independently of the apparatus, for example, as a source of calibration gas.

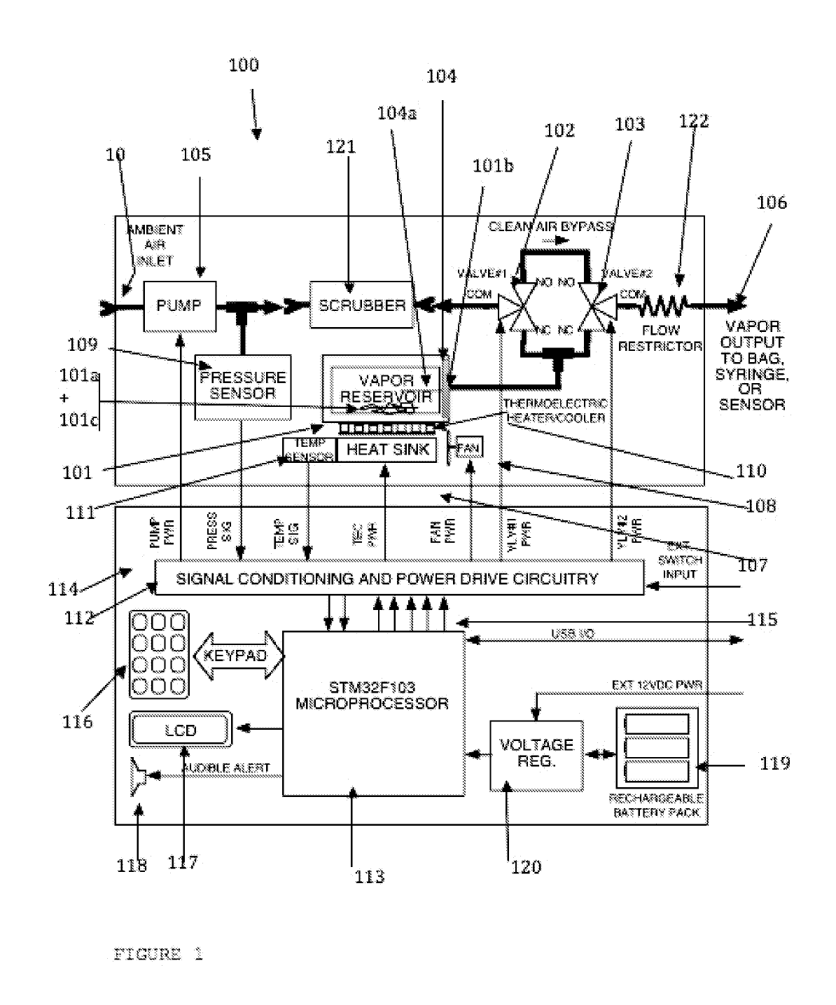

The apparatus 100 according to this invention is shown schematically in FIG. 1. A vapor reservoir 101 which contains a liquid 101c (which is the source of the vapor or gas or a liquid which contains the vapor to be generated). The vapor reservoir is a small, constant volume vapor reservoir vial. The reservoir 101 is preferably made from glass, plastic or metal or other material known in the art or which is hereafter discovered that is not degraded by chemical housed in the reservoir.

Commercially available 2 cc “crimp-top” glass vials (e.g., Restek P/N 21152) are particularly attractive for this application. The vial preferably contains a “wick” material 101a (e.g. glass wool, cotton, zeolites, polymer foams, charcoal, cardboard, cloth, or other material known in the art or which is hereafter discovered) that is chemically inert to the chemicals in the reservoir and which retains the liquid while allowing vapor from the liquid to fill the remaining headspace in the vial 101 with an equilibrium concentration for the given vial temperature and pressure. In one embodiment according to this invention, the opening of the vial 101b is sealed using a ‘crimped-on” elastomeric septum material 104. Alternatively, of course, those skilled in the art will appreciate that alternatives to a septum, including but not limited to O-rings, gaskets and the like, and combinations thereof, may be employed to achieve this function. The seal, e.g. septum material, 104 may be comprised of a material such as but not limited to silicone, butyl rubber, combinations thereof, or other material or combination of material known in the art or which is hereafter discovered. Commercially available “crimp-caps” or the equivalent having silicone or butyl rubber septa with a PTFE (polytetrafluoroethylene) surface (e.g., Restek P/N 24444) facing the reservoir are particularly preferred for this purpose. The septum material 104 seals the vial while allowing a small hollow needle, tube, or the equivalent 104a to be inserted into the vial while retaining a seal to the ambient air. This arrangement allows small quantities of vapor to be dispensed from the vial 101 when its internal pressure is increased, even slightly, above atmospheric pressure. This is achieved by methods and devices known in the art, including, but not limited to any known source of positive pressure, such as a small pump 105 (including, but not limited to, a diaphragm pump, rotary vane pump, syringe pump, peristaltic pump or the equivalent, now known which is hereafter developed), and the applied pressure is controlled via a pressure sensor 109. A pair of electrically activated solenoid valves 102, 103 allow pressurized scrubbed air from the pump 105 to be directed into the vial 101 or to the outlet 106 via flow restrictor 122 to serve as dilution air or calibration gas.

A typical operating sequence begins by setting the temperature of the vapor reservoir 101 by energizing a thermoelectric heater/cooler 110 attached to the reservoir 101. A temperature sensor 111 attached to the reservoir 101 measures the temperature of the vapor reservoir 101 and signals an electronic control circuit 112, having the function of signal conditioning and providing power drive circuitry, controlled by a programmable microprocessor 113 (for example, but not limited to, an STM32F103 microprocessor commercially available from Digi-Key P/N 497-6066-ND) to increase or decrease the control temperature. The controller 113 compares the temperature measured by the temperature sensor 111 to a desired set-point temperature stored in memory resident in or associated with said microprocessor 113 and power is applied to the thermoelectric element 110 to heat or cool the vapor reservoir 101 as required to maintain the set-point temperature stored in the microprocessor 113 memory. A heat sink, 107 is provided to enable quick cool-down of the reservoir 101 as needed, with a fan 108 provided to ensure even and rapid distribution of heat to and from the reservoir 101. An important advantage of this scheme is that it allows the vapor reservoir 101 to be maintained at sub-ambient temperatures. This reduces the vapor pressure of the test vapor, thereby making it easier to achieve low vapor concentrations. This arrangement also eliminates the possibility of vapor condensation on the valves and connecting tubing, since they are at a warmer (i.e., warmer than the vapor) temperature. The small size of the vapor reservoir 101 affords the advantage of having a very small thermal mass, thereby allowing rapid temperature stabilization and a correspondingly lower need for electrical power to maintain any required set-point temperature. The electronic control circuit 112, having the function of signal conditioning and providing power drive circuitry communicates with each of the internal components via communication channels indicated by arrows 114, and channels 115, between the microprocessor 113 and the signal conditioning and power drive circuitry 112. In order to provide a user interface for controlling and programming purposes, there is provided a keypad 116, with visual display of information being provided on an LCD 117 or the equivalent. A speaker or equivalent means 118 provides audible alerts as and when needed. Power is provided via, for example, a rechargeable battery pack, 119, which, via a voltage regulator 120 (to which external power may be connected) provides power to all other system components.

Once the temperature of the vapor reservoir 101 has been stabilized, the headspace vapor concentration becomes constant. Precise volumes of this headspace vapor can be dispensed by setting the valves 102, 103 to allow a pump 105 (or other source of pressurized gas) to be connected to the reservoir. This action increases the pressure inside the vapor reservoir 101. The valves 102, 103 can then be switched to allow the pressurized vapor reservoir to release a small volume of the headspace vapor via flow restrictor 122 and thence via port 106. By controlling the pressure applied to the reservoir and the time duration that the valves are switched to release the headspace vapor, very precise control of the dispensed headspace volume is achieved.

From the foregoing detailed description of the device, it will be clear to those skilled in the art that the apparatus of this invention dispenses pulses of vapor whose temperature, pressure and volume are precisely known. Under these conditions, the Ideal Gas Law stipulates that the number of vapor molecules is also known.

While some sensors can be calibrated using pulses containing a known number of vapor molecules, most are calibrated using a constant vapor concentration. This invention allows the preparation of constant vapor concentrations by collecting one or more vapor pulses into a reservoir (e.g., a flexible plastic bag or gas-tight syringe) and filling the reservoir with a known volume of clean air. Clean air is obtained by pumping ambient air via ambient air inlet 10 through a scrubber 121 containing sorbents for water vapor (e.g., “Drierite”™, molecular sieves, Calcium Sulfate, silica gel, or any other like moisture absorber now known or which comes to be known hereafter) and sorbents for trace organic vapors (e.g., activated charcoal). The resulting air is relatively free of all molecules except air and can serve as a suitable diluent for the vapor pulse(s). This source of pressurized, clean air can then be metered into the reservoir (e.g., bag or syringe) by using a flow sensor or by simply delivering air at a constant pressure through a constant flow restriction for a known time, to provide a known volume of clean air. Thus, by injecting a known number of molecules of vapor into a reservoir and filling that reservoir with a known volume of clean air, an accurately known vapor concentration can be prepared.

It will be appreciated from the foregoing description of a first embodiment of the invention that equivalents thereto come within the scope of this invention. Furthermore, it will be appreciated from the foregoing description that additional, alternative embodiments of the invention are useful in various situations. The embodiment described herein above may be considered to be a “1-port” design with a relatively small, e.g. septum-capped reservoir, comprising a single entry port into a bottle, sealed container and the like. That embodiment operates very well when the vapor reservoir is of a small volume. However, a small volume reservoir, of course, can only hold a small volume of the source vapor, thus limiting the useful life of the vapor source before recharging or replacement of the vapor source is required.

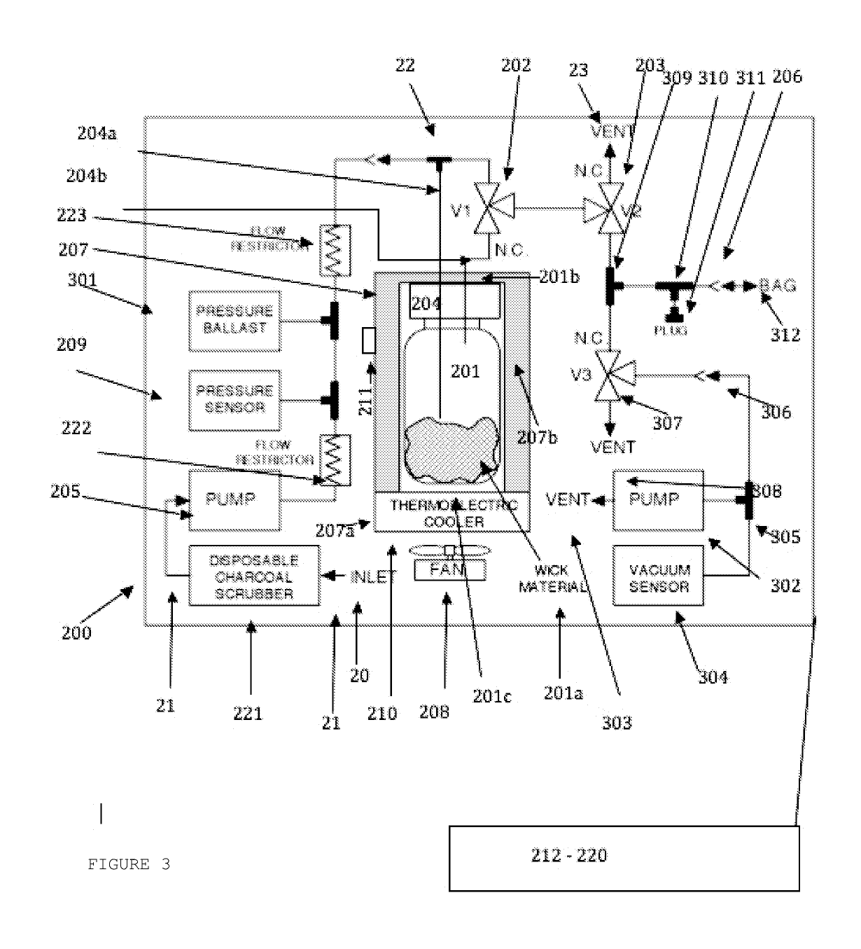

When larger vapor sources are needed, an embodiment comprising a 2-port design illustrated in FIG. 3 and described in detail below, may be preferred, as it provides certain advantages. In such an embodiment, the reservoir (bottle or the like) is desirably always pressurized by a carrier gas, as further described herein below.

With reference to FIG. 3, this embodiment of the invention 200 comprises many elements that are similar to, equivalent to, or even identical to, elements described in the embodiment depicted in FIG. 1. To the extent possible, elements with like, equivalent or identical structure and/or function are described in FIG. 3 using reference numerals in the 200 series, but terminating in numerals similar to those used in the 100 series. Thus, in the FIG. 3 embodiment, the device 200 comprises a vapor reservoir 201 which contains a liquid 201c (which is the source of the vapor or gas or a liquid which contains the vapor to be generated). The vapor reservoir in this embodiment is a constant volume vapor reservoir vial with a greater volume than that shown in the FIG. 1 embodiment. The reservoir 201 is preferably made from glass, plastic or metal or other material known in the art or which is hereafter discovered that is not degraded by chemical housed in the reservoir. Commercially available “crimp-top” or screw-top vials with a volume of 2 to 200 cc are particularly attractive for this application. The vial preferably contains a “wick” material 201a (e.g. glass wool, cotton, zeolites, polymer foams, charcoal, cardboard, cloth, or other material known in the art or which is hereafter discovered) that is chemically inert to the chemicals in the reservoir and which retains the liquid while allowing vapor from the liquid to fill the remaining headspace in the vial 201 with an equilibrium concentration for the given vial temperature and pressure. The vial opening 201b is sealed using an elastomeric material associated with the crimp-top or screw-top or it may be enclosed in a chamber 207 which may perform one or more of the following functions: compression closure of the reservoir 201, operation as a heat sink, or both. For compression closure purposes, the vial 201 is installed above a platform 207a which preferably operates as a thermoelectric cooler 210, and a clamp or cylinder 207b is positioned over the vial 201 and is releasably affixed to the platform 207a by any appropriate means, including but not limited to screws, clamps, clips, and the like. The positioned clamp, cylinder or housing 207b is preferably dimensioned such that the top 201b of the reservoir 201 is biased to form a gas-tight seal. As with element 104 of embodiment 100, the seal may be comprised of a septum, O-rings, gaskets and the like, and combinations thereof. The seal, e.g. elastomeric septum material, 204, may be comprised of a material such as but not limited to silicone, butyl rubber, combinations thereof, or other material or combination of material known in the art or which is hereafter discovered. Commercially available “crimp-caps” or the equivalent having silicone or butyl rubber septa with a PTFE (polytetrafluoroethylene) surface facing the reservoir are particularly preferred for this purpose. The septum material 204 seals the vial while allowing hollow needles, tubes, or the equivalent 204a, 204b, to be inserted into or retained in the vial while retaining a seal to the ambient air. This arrangement allows for precise quantities of vapor to be dispensed from the vial 201 when its internal pressure is increased, even slightly, above atmospheric pressure. This is achieved by methods and devices known in the art, including, but not limited to any known source of positive pressure, such as a pump 205 (including, but not limited to, a diaphragm pump, rotary vane pump, syringe pump, peristaltic pump or the equivalent, now known which is hereafter developed), and the applied pressure is controlled via a pressure sensor 209. A temperature sensor 211 is attached to the housing 207b, to regulate the temperature of the reservoir 201. A pair of electrically activated solenoid valves 202, 203 (V1, V2) allow pressurized scrubbed air from the pump 205 to be directed into the vial 201 or to the outlet 206 to serve as dilution air or calibration gas.

Due to the greater volume capabilities of this embodiment of the invention, and the somewhat greater complexity required to achieve its functions, additional elements are preferably included in this embodiment, for which a direct correlate component is not described in the first embodiment 100 of the invention described herein above. These additional elements are described herein, below, in the course of describing a typical operating sequence of this embodiment of the invention. By contrast, elements shown for the embodiment 100 which are essentially identical to elements employed in the embodiment 200 are not discussed in detail or shown in FIG. 3. Thus, signal conditioning and power drive circuitry 212, microprocessor 213, voltage regulator 220, battery pack 219 etc. (elements 112-120) shown in FIG. 1, have similar counterparts (elements 212-220, for which reference can be had to FIG. 1 and transposing numbered elements 112-120 with elements 212-220) in the embodiment 200 which are not shown in detail in FIG. 3.

In a typical operating sequence, ambient air is drawn into the system via inlet 20, by activation of pump 205, causing the ambient air to be drawn into pneumatic system 21, (which extends throughout the system) and then pass through disposable charcoal scrubber 221. Those skilled in the art, based on the present disclosure, will appreciate that precise location of the pump 205 in relation to the scrubber 221 may be varied from that shown in FIG. 3, without departing from the central feature of the invention. For example, the pump 205, rather being located after the scrubber 221, in relation to the inlet 20, may be located prior to the scrubber. The same can be said for the location of other elements of this system. The scrubbed air then passes through flow restrictor 222 and the pressure sensor 209 determines the system pressure. Scrubbed air then passes, via pressure ballast 301, (which provides the ability to rapidly regulate system pressure), and then through flow restrictor 223. The pneumatic line 21 splits at coupling 22, with a first portion 204a of the pneumatic line 21 terminating inside the reservoir 201. Thus, pressure sensor 209, when valve 202 is closed, reads the pressure in the system up to and including inside the reservoir 201.

Energizing valve 202, (also labeled V1 in FIG. 3), allows an immediate discharge of small pulse of gas without the time delay associated with pressurizing the reservoir volume prior to releasing the pressure as in the 1-port embodiment, 100.

Alternatively, valve 203 (also labeled V2 in FIG. 3), can be activated to vent a pulse of vapor from valve 202 (V1) to flush the valve and associated tubing so that subsequent vapor pulses will provide reproducible vapor concentrations.

The temperature of the vapor reservoir 201 is set, (as in the embodiment 100), by energizing a thermoelectric heater/cooler 210 attached to the reservoir 201. Temperature sensor 211, attached to the reservoir 201, measures the temperature of the vapor reservoir 201 and signals electronic control circuit 212, having the function of signal conditioning and providing power drive circuitry, controlled by a programmable microprocessor 213 (for example, but not limited to, an STM32F103 microprocessor commercially available from Digi-Key P/N 497-6066-ND), to increase or decrease the control temperature. The controller 213 compares the temperature measured by the temperature sensor 211 to a desired set-point temperature stored in memory resident in or associated with said microprocessor 213 and power is applied to the thermoelectric element 210 to heat or cool the vapor reservoir 201 as required to maintain the set-point temperature stored in the microprocessor 213 memory. Heat sink 207 is provided to enable quick cool-down of reservoir 201 as needed, with fan 208 provided to ensure even and rapid distribution of heat to and from the reservoir 201. In this way, reservoir 201 may be maintained at sub-ambient temperatures. This reduces the vapor pressure of the test vapor, thereby making it easier to achieve low vapor concentrations. This arrangement also eliminates the possibility of vapor condensation on the valves and connecting tubing, since they are at a warmer (i.e., warmer than the vapor) temperature. While having a larger size than in the embodiment 100 described above, the embodiment 200 still has a relatively small vapor reservoir 201 affording the advantage of having a small thermal mass, thereby allowing rapid temperature stabilization and a correspondingly lower need for electrical power to maintain any required set-point temperature. The electronic control circuit 212, having the function of signal conditioning and providing power drive circuitry, communicates with each of the internal components via communication channels indicated by arrows 214, and channels 215, between the microprocessor 213 and the signal conditioning and power drive circuitry 212. In order to provide a user interface for controlling and programming purposes, there is provided a keypad 216, with visual display of information being provided on an LCD 217 or the equivalent. A speaker or equivalent means 218 provides audible alerts as and when needed. Power is provided via, for example, a rechargeable battery pack, 219, which, via a voltage regulator 220 (to which external power may be connected) provides power to all other system components.

Once the temperature of the vapor reservoir 201 has been stabilized, the headspace vapor concentration becomes constant. Precise volumes of this headspace vapor are dispensed by setting the valves 202, 203 such that pressurized vapor reservoir 201 releases a precise volume of the headspace vapor via pneumatic line 21 originating in the reservoir 201 at port 204b. When valve 202 (V1) in this embodiment is opened, vapor is conducted via pneumatic line 21 to valve 203 (V2) which can be opened to vent 23, or to coupling 309 via further coupling 310 and out of port 206. Coupling 310 optionally includes a removable plug 311. This port facilitates the connection of the device to more than one output at any given time. Port 206 may be connected to an external device or to, e.g. a bag 312 or other receptacle for dispensed vapor collection. By controlling the pressure applied to the reservoir and the time duration that the valves are switched to release the headspace vapor, very precise control of the dispensed headspace volume via port 206 is achieved.

In the embodiment 200, a further refinement may optionally be included by incorporating, beyond coupling 309, a further valve 307 (V3 in FIG. 3) which is in a normally closed orientation (N.C. in FIG. 3). Where valve 307 (V3) is included, this embodiment further preferably includes pneumatic tubing 21 connecting valve 307 via coupling 306 and three way coupling 305 to vacuum pump 302 (connected to vent 303) and vacuum sensor 304, to provide a means to prepare sample bags for use. When valves 203 and 307 (V2, V3) and the vacuum pump 302 are energized, all residual gas in a bag 312 attached to the system at 206 is removed from the bag. Vacuum sensor 304 provides a signal to the controller that allows vacuum pump 302 to be de-energized when the vacuum level exceeds a preset threshold. Once bag 312 is empty, valves 203 and 307 (V2, V3) and vacuum pump 302 are de-energized, thereby allowing clean carrier gas to flow into the bag. After a preset volume of “zero air” has been dispensed to bag 312, valves 203 and 307 (V2, V3) and vacuum pump 302 are re-energized to once again evacuate the bag. This cleaning process, i.e., evacuation and filling with zero air, is repeated as many times as desired to provide assurance that all residual vapors have been cleared from bag 312. This scheme also provides the advantage that the system can easily supply “zero” air from charcoal scrubber 221 that can be used to adjust the zero setting to calibrate a detector.

A further unique feature of the device according to this invention is that it affords self-correction of the vapor concentration as the reservoir is depleted. There is a fixed amount of the vapor initially available in reservoir that becomes slowly depleted every time a vapor pulse is dispensed. Because the initial mass of vapor in the bottle is known and the mass of vapor dispensed with each valve (V1) (102, 202) pulse is also known, the new headspace concentration is optionally continuously recalculated. Utilizing the “corrected” vapor headspace concentration, the valve pulse duration is slowly increased to allow a constant mass of vapor to be dispensed, even though the headspace concentration gradually falls with use. This process is readily monitored and controlled by the microprocessor and greatly extends the useful life of the vapor reservoir before re-filling is required. Specifically, the mass of vapor initially present in the vial is known (e.g., 100 mg) and the mass of vapor dispensed with each pulse is known (e.g., 100 ng). Knowledge of these two quantities allows the remaining mass in the vial to be re-calculated after each vapor pulse by simply subtracting the mass of vapor pulses delivered from the starting mass in the vial. Since the volume of the vial is a constant, then the concentration of vapor in the vial (i.e., the mass/volume) is subject to real time, iterative recalculation by the microprocessor 213. This revised concentration is utilized by the microprocessor to re-calculate the timing of the valve pulse to assure that the same vapor mass is delivered. In a typical application (e.g., 100 mg starting vapor mass and 100 ng mass delivered in each vapor pulse), the injection valve timing is increased by approximately 0.0001% (i.e., 100 ng/100 mg) with each pulse in order to maintain a constant mass delivery. Based on this disclosure, those skilled in the art are able to define algorithms, software code and equivalents thereof for inclusion in the microprocessor 213 memory to achieve this result.

In light of the foregoing disclosure relating to embodiment 200 of this invention, those skilled in the art will appreciate that alternate embodiments according to this invention accommodate excellent portability and smallness of footprint (embodiment 100 and equivalents thereof, FIG. 1), and greater longevity of use with slightly greater footprint comprising a larger “2-port” reservoir design (embodiment 200 and equivalents thereof, FIG. 3).

It will further be appreciated that an embodiment of the device according to this invention optionally includes an additional valve, pump and vacuum sensor that can be used to pre-condition sample bags for use with the device.

It will yet further be appreciated that an embodiment according to this invention provides a running tally of the amount of vapor dispensed and adjusts (i.e., increases) the injection valve pulse duration to provide a constant mass in each pulse even though the reservoir concentration drops with time.

Having generally described this invention above, the following additional description ensures detailed disclosure which enables those skilled in the art to practice this invention to the full extent of the claims appended to this disclosure.

Embodiment 100 of the device of this invention is small (e.g., <40 cubic inches with approximate dimensions of 2.5″×3.5″×4.5″) and uses relatively little electrical power (e.g., 6 Volts DC @ 250 mA (average)) making it suitable as a hand-held, battery-powered calibration device, or as a calibration device that can be built into the measurement sensor system.

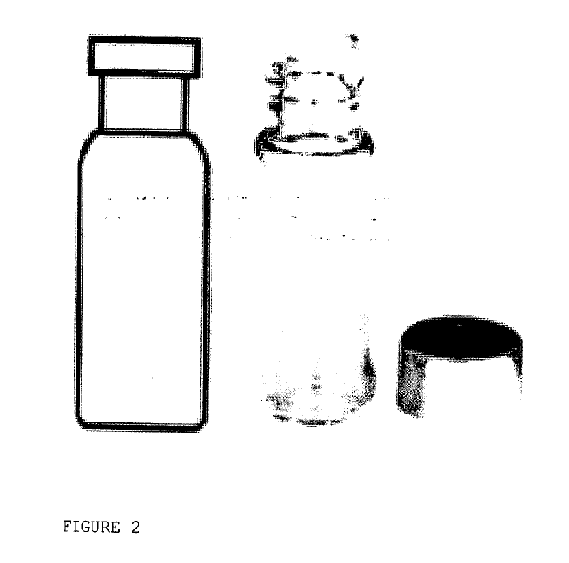

The device utilizes a small vapor reservoir such as a common 2 cc crimp-top septum vial (see FIG. 2) that can easily be installed and removed, thereby allowing the calibration device to be used for a variety of different vapors. The size of the vial can be much smaller or much larger than 2 cc depending on the particular vapor, concentration, stabilization time and reservoir lifetime that is required for the particular application. The device, when included in a system for vapor calibration, provides a source of clean, “zero” air for re-zeroing of the sensor response.

The active control of temperature, pressure and delivery volume allows this system to maintain high accuracy over a range of ambient environmental conditions.

The septum-topped vapor reservoir is sealed and eliminates problems with leakage, making the system robust and amenable for transportation or use in a wide variety of contexts.

The device according to this invention does not use compressed gas cylinders and thus can be transported easily without safety concerns.

By programming higher pump pressures, or longer injection times, or multiple injection pulses, it is possible to deliver a broad range of vapor concentrations, rather than being restricted for use at a single concentration.

By holding the vapor reservoir at a temperature that is cooler than ambient temperature, problems associated with vapor condensation downstream of the reservoir are reduced or eliminated.

Embodiment 200 is slightly larger than embodiment 200, as defined, primarily, on the size of the included vapor reservoir and operates substantially similarly to that of embodiment 100, with

It will therefore be appreciated that the device of this invention accommodates a plurality of alternate embodiments and uses, as follows:

1) Use of a variety of vapor source materials: The vapor reservoir can contain pure chemicals that are liquids at room temperature (e.g., ethanol, benzene, methyl salicylate, dimethylmethylphosphonate, and the like) or solids that have a significant vapor pressure at room temperature (e.g., para-dichlorobenzene). Likewise the source can contain mixtures of liquids to allow simultaneous calibration of multiple vapors (e.g., benzene, toluene, xylene). It is also possible to use liquids (e.g., water) that are in equilibrium with a volatile gas (e.g., ethylene oxide, ammonia, chlorine, hydrogen sulfide, and the like). Furthermore it is possible to use dilute solutions of an organic component (e.g., 2,6-diisopropylphenol) in a solvent (e.g., water) to allow very low concentrations of the organic vapor to be delivered.

2) The vapor reservoir vial can contain liquid by itself or an inert wick material (e.g., glass wool) along with the liquid that can prevent the liquid from pooling.

3) A wide variety of materials can be used to construct the device as long as the materials in contact with the liquids and vapors do not significantly absorb the vapors and are not degrade by the vapors. Preferred materials include glass; non-porous plastics; metals such as stainless steel, brass, aluminum and any metal with surface plating that is non-reactive such as nickel, chromium and gold.

4) Temperature measurements can be performed by any convenient electronic device, (e.g., thermocouple, thermistor, RTD, semiconductor temp sensor, and the like).

5) The measurement of pressure can be performed by any convenient electronic device, (e.g., silicon strain gauges, MEMS piezoresistors, MEMS capacitors, and the like).

6) The measurement of volume can be performed by any convenient method. Preferred methods include using a calibrated electronic flowmeter, and a clock (contained in the microprocessor) to determine when the desired volume has been delivered. Alternatively the volume can be determined by using a supply of air at a constant pressure that is delivered through a constant flow restriction. This scheme produces a constant flow rate that can be timed by the microprocessor clock to establish when the desired volume has been delivered.

### EXAMPLES

While the foregoing disclosure provides a thorough, enabling written description of this invention, without detracting from the generality thereof, the following additional, exemplary, support is provided to ensure that those skilled in the art are fully able to practice the disclosed and claimed invention, and equivalents thereof. The scope of this invention is not restricted by this exemplary support and reference should be had to the appended claims and their equivalents for an appreciation of the full scope of the invention.

### Example 1

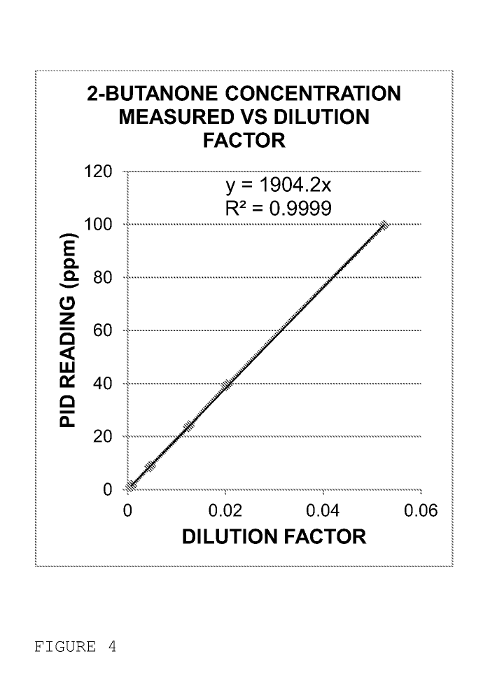

The operation of the method and system according to this invention, which utilizes an embodiment of the device according to this invention is demonstrated using an aqueous solution of 2-butanone (i.e., 100 μL 2-butanone in 10 mL distilled water) applied to a glass-fiber wick (Johns-Manville) in the 2-port (embodiment 200, FIG. 3, reservoir). The device delivered 2-butanone vapor to a 1 L Tedlar™ sampling bag (SKC). After delivering 1 liter of sample to the bag, the bag was disconnected from the device and sampled using a calibrated photoionization detector (PE-Photovac 2020 PID). The reservoir was held at a temperature of 15° C. and the carrier flow rate was set to 200 sccm. The resulting data are illustrated in FIG. 4, showing excellent linearity as the dilution factor is varied by changing the V1 (102, 202) pulse duration.

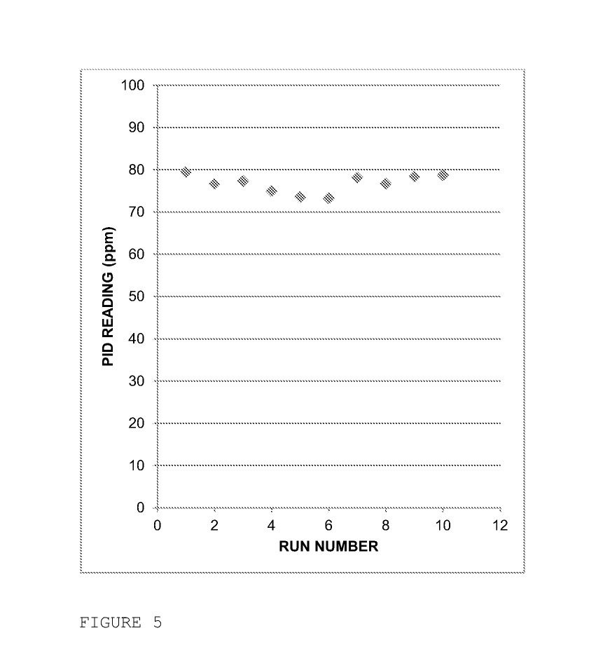

The repeatability of the device was verified by preparing 10 consecutive 1-liter samples of 2-butanone vapor into a 1-liter Tedlar bag. Each measurement was conducted from a “cold-start”, i.e., the instrument was initially unpowered and at room temperature before being turned-on. The system then re-established the reservoir temperature and carrier flow rate before beginning the vapor delivery to the 1-liter bag. The PID readings for the 10 consecutive bags of vapor are illustrated in FIG. 5. As can be seen, an average 2-butanone concentration of 76.7 ppmv was measured with a relative standard deviation of ±2.8%. These results are acceptable for the intended use.

What is claimed is:

1. An apparatus for accurate gas and vapor concentration preparation and dispensation comprising:
a constant volume reservoir containing a vapor source, said vapor source comprising a liquid containing the vapor to be generated, such that said liquid in said reservoir is in equilibrium with a headspace volume in said reservoir at a given reservoir temperature;
a temperature control for precisely controlling the temperature of said constant volume reservoir;
a source of positive pressure for imparting a precisely controlled pressure to the interior of said constant volume reservoir; and
a seal through which at least one tube is insertable into or through which it is sealingly maintained, said constant volume reservoir, while maintaining a seal to ambient air surrounding said reservoir, such that precisely metered quantities of vapor are dispensed from said reservoir via said at least one tube, upon pressurization of said constant volume reservoir to a pressure above atmospheric pressure.

2. The apparatus according to claim 1 comprising at least one or a combination of the following additional features:
a. said constant volume reservoir comprises a wick in association with said liquid containing said vapor;
b. said source of positive pressure is a pump;
c. (i) a pair of electrically activated solenoid valves which allow pressurized scrubbed air from said source of positive pressure to be directed into said constant volume reservoir or an outlet of said device when preparing a reservoir of calibration gas or (ii) a series of a first, a second and a third electrically activated solenoid valve, wherein said first and said second valves are oriented so as to allow pressurized scrubbed air from said source of positive pressure to be directed into said constant volume reservoir or an outlet of said device when preparing a reservoir of calibration gas and said third valve is disposed in connection with a pump and a vacuum sensor to facilitate pre-conditioning of the contents of a gas receptacle into which said apparatus delivers gas;
d. a means for retaining a running tally of the amount of vapor dispensed;
d. dimensions and weight suitable as a hand-held, battery-powered calibration device, or as a calibration device that can be built into a measurement sensor system;
e. a vial that is easily installed and removed, thereby allowing the apparatus to be used for a variety of different vapors; and
f. a vapor which contains pure chemicals that are liquids at room temperature or solids that have a significant vapor pressure at room temperature or mixtures of liquids to allow simultaneous calibration of multiple vapors, or mixtures of liquids and solids.

3. The apparatus according to either claim 1 or 2 included in a system for vapor calibration which provides a source of clean, “zero” air for re-zeroing of the response of a sensor.

4. The apparatus according to claim 2 which retains a running tally of the amount of vapor dispensed, and which, based on the running tally of vapor dispensed, adjusts the injection valve pulse duration to provide a constant mass in each pulse even though the reservoir concentration drops with time.

5. A method for providing accurate gas and vapor concentrations to a chemical sensor requiring calibration, comprising:
providing a constant volume reservoir containing a vapor source, said vapor source comprising a liquid containing the vapor to be generated, such that said liquid in said reservoir is in equilibrium with a headspace volume in said reservoir at a given reservoir temperature;
providing a temperature controllrt for precisely controlling the temperature of said constant volume reservoir;
providing a source of positive pressure for imparting a precisely controlled pressure to the interior of said constant volume reservoir; and providing a seal through which at least one tube is insertable into or through which it is sealingly maintained, said vial, while maintaining a seal to ambient air surrounding said reservoir, such that precisely metered quantities of vapor are dispensed from said reservoir via said at least one tube to a chemical sensor requiring calibration, upon pressurization of said constant volume reservoir to a pressure above atmospheric pressure, by said source of positive pressure.

6. The method according to claim 5 further comprising at least one or a combination of the following steps:
a. setting the temperature of the constant volume reservoir by energizing a thermoelectric heater/cooler attached to the reservoir;
b. measuring the temperature of said constant volume reservoir with a temperature sensor attached to the reservoir;
c. signaling an electronic control circuit to compare the temperature of said constant volume reservoir by said sensor attached to said reservoir with a set-point temperature stored in memory of said control circuit such that said control circuit applies power a thermoelectric element to heat or cool said constant volume reservoir as required to maintain said set-point temperature;
d. on stabilization of the temperature of said constant volume reservoir, dispensing precise volumes of headspace vapor by setting the valves to apply positive pressure to said reservoir, thereby increasing pressure inside said vapor reservoir;
e. switching valves to allow release of a precise volume of headspace vapor;
f. collecting at least one pulse of constant vapor concentration into a vapor pulse collection reservoir and filling said vapor pulse collection reservoir with a known volume of clean air;
g. obtaining clean air by pumping ambient air through a scrubber containing sorbents of water vapor, sorbents of trace organic vapors, or both; and
h. metering into said vapor pulse collection reservoir a known volume of clean air.

7. The method according to claim 6 wherein said metering is achieved by using a flow sensor or by delivering air at a constant pressure through a constant flow restriction for a known time.

8. The method according to claim 7 comprising producing an accurately known vapor concentration in said pulse collection reservoir by injecting a known number of molecules of vapor into said pulse collection reservoir and filling said pulse collection reservoir with a known volume of clean air.

9. The method according to claim 5 which comprises introducing pressurized scrubbed air from said source of positive pressure to be directed into said constant volume reservoir or an outlet of said device when preparing a reservoir of calibration gas and pre-conditioning of the contents of a gas receptacle into which gas is delivered.

10. The method according to claim 5 further comprising retaining a running tally of the amount of vapor dispensed.

11. The method according to claim 10 further comprising, based on the running tally of vapor dispensed, adjusting the injection valve pulse duration to provide a constant mass in each pulse even though the reservoir concentration drops with time.

12. A system for accurate gas and vapor concentration preparation and dispensation to a chemical sensor requiring calibration, comprising:
a constant volume reservoir containing a vapor source, said vapor source comprising a liquid containing the vapor to be generated, such that said liquid in said reservoir is in equilibrium with a headspace volume in said reservoir at a given reservoir temperature;
a temperature controller for precisely controlling the temperature of said constant volume reservoir;
a source of positive pressure for imparting a precisely controlled pressure to the interior of said constant volume reservoir; and
a seal through which at least one tube is insertable into or through which it is sealingly maintained, said constant volume reservoir, while maintaining a seal to ambient air surrounding said reservoir, such that precisely metered quantities of vapor are dispensed from said reservoir via said at least one tube to a chemical sensor requiring calibration, upon pressurization of said constant volume reservoir to a pressure above atmospheric pressure, by said source of positive pressure.

13. The system according to claim 12 comprising at least one or a combination of the following additional features:
a. said constant volume reservoir comprises a wick in association with said liquid containing said vapor;
b. said source of positive pressure is a pump;
c. (i) a pair of electrically activated solenoid valves which allow pressurized scrubbed air from said source of positive pressure to be directed into said constant volume reservoir or an outlet of said device when preparing a reservoir of calibration gas or (ii) a series of a first, a second and a third electrically activated solenoid valve, wherein said first and said second valves are oriented so as to allow pressurized scrubbed air from said source of positive pressure to be directed into said constant volume reservoir or an outlet of said device when preparing a reservoir of calibration gas and said third valve is disposed in connection with a pump and a vacuum sensor to facilitate pre-conditioning of the contents of a gas receptacle into which said apparatus delivers gas;
d. a means for retaining a running tally of the amount of vapor dispensed;
e. dimensions and weight suitable as a hand-held, battery-powered calibration device, or as a calibration device that can be built into a measurement sensor system;
f. a vial that is easily installed and removed, thereby allowing the calibration device to be used for a variety of different vapors;
g. a vapor which contains pure chemicals that are liquids at room temperature or solids that have a significant vapor pressure at room temperature or mixtures of liquids to allow simultaneous calibration of multiple vapors, or mixtures of liquids and solids; and
h. a source of clean, “zero” air for re-zeroing of the response of a sensor.

14. The system according to claim 13 which retains a running tally of the amount of vapor dispensed, and which, based on the running tally of vapor dispensed, adjusts the injection valve pulse duration to provide a constant mass in each pulse even though the reservoir concentration drops with time.

15. The system according to claim 12 when used in combination with a device requiring vapor calibration or with a vapor receptacle attached to an apparatus comprising the elements of claim 12.
